(19) United States
(12) Patent Application Publication
(10) Pub. No.: US 2014/0251927 A1
(43) Pub. Date: Sep. 11, 2014

(54) Porous Polymeric Particles and Methods of Making and Using Them

(71) Applicant: Nathan T. Starbard, Boston, MA (US)

(72) Inventor: Nathan T. Starbard, Boston, MA (US)

(21) Appl. No.: 14/280,817

(22) Filed: May 19, 2014

Related U.S. Application Data
(63) Continuation of application No. PCT/US12/71931, filed on Dec. 28, 2012.

(51) Int. Cl. B01D 24/00

(52) U.S. Cl. CPC B01D 24/00
USPC 210/767; 210/263; 264/13; 427/222; 427/569

(57) ABSTRACT

The invention relates to a porous polymeric particle that may be used as a filtration or separation media. For example, the particle may be used as part of a filtration device such as those utilized by the beverage, pharmaceutical, or biotechnology industry, or as a loose filtration media similar to diatomaceous earth, which is used in equipment such as pressure leaf, candle, press, or rotary vacuum filters. Methods of making the porous particles are also described.

### RELATED APPLICATIONS

This application is a continuation of Patent Cooperation Treaty Application serial number PCT/US12/071,931, filed Dec. 28, 2012, the entirety of which is hereby incorporated by reference.

### BACKGROUND

The filtration and separation of material from fluid streams is of critical importance to many industries. Pharmaceutical, beverage, and industrial manufacturers spend enormous amounts of time and effort on a multitude of filtration and separations technologies used in their various processes.

The majority of filtration media currently used includes solvent cast, immersion precipitated, or phase separated polymeric tubes or sheets, cellulosic media, woven or spun polymers, and sintered ceramics or metals. These types of filtration media are typically enclosed within or incorporated into a filtration device such as a cartridge, cassette, capsule, specialty molded container, and so forth. A considerable amount of diatomaceous earth in bulk powder form is also used as a filtration media, primarily in beverage processes.

Diatomaceous earth (DE) is the fossilized remnants of ancient diatoms that are mined from the earth, milled, and used as a loose filter media in equipment such as press filters, rotary vacuum filters, pressure leaf filters, and candle filters. Diatomaceous earth is sometimes incorporated into other filtration media, such as cellulosic based depth media or media constructed from polypropylene fibers. Impregnating these materials with diatomaceous earth improves their filtration capacity and performance. Perlite is a mined mineral that has similar characteristics to diatomaceous earth and is used in the same capacity on the same equipment. Perlite is generally regarded as being lower performing with many of the basic drawbacks as DE, and so its use is more limited.

Chromatography is a filtration and/or separations technology that performs primarily by adsorption or binding to remove materials or contaminants from a fluid stream. Many chromatography media possess a porosity that allows for size exclusion filtration in addition to binding or adsorption; these media perform better in many applications in terms of capacity, flow mechanics, surface area, and so forth.

Surface treatments are often applied to polymeric membrane filter media to improve or change certain characteristics such as hydrophilicity or hydrophobicity, protein binding, flow mechanics, chemical compatibility, and binding or adsorption capacity or capability. Such surface treatments typically include coating, grafting, chemical oxidation, ligand binding, plasma treating, and crosslinking. Such techniques are widely used in current membrane manufacturing. More recent advances feature surface treatments of sheet or tubular polymeric membranes to imbue the membrane with adsorptive or binding capacity or capabilities, thereby adding chromatographic properties to the membrane.

There exists a need for separation media with a high filtration capacity in a low volume format that can be easily incorporated into single use formats currently on the market. There also exists a need for a viable alternative to diatomaceous earth for use in filtration applications.

### SUMMARY OF THE INVENTION

In certain embodiments, the invention relates to a method of forming a plurality of porous polymeric particles comprising the steps of

contacting a polymer in a solvent, thereby creating a solution;

spraying the solution from a nozzle into a container, thereby creating a plurality of particles;

subjecting the plurality of particles to a first temperature, wherein the first temperature is less than about 15° C., thereby forming a plurality of frozen particles; and

removing substantially all of the solvent from the plurality of frozen particles, thereby forming a plurality of porous polymeric particles.

In certain embodiments, the invention relates to a porous polymeric particle made by any one of the aforementioned methods.

In certain embodiments, the invention relates to a filtration or separation medium, wherein the filtration or separation medium comprises a plurality of porous polymeric particles made by any one of the aforementioned methods.

In certain embodiments, the invention relates to a device, wherein the device comprises a plurality of porous polymeric particles made by any one of the aforementioned methods.

In certain embodiments, the invention relates to filtration equipment, wherein the filtration equipment comprises a porous polymeric particle made by any one of the aforementioned methods.

In certain embodiments, the invention relates to a method for separating a substance from a fluid, comprising the step of:

contacting with a fluid at a flow rate a porous polymeric particle made by any one of the aforementioned methods,

wherein

the fluid comprises a substance; and

the pores of the porous polymeric particles are of sufficient size to substantially trap the substance, thereby separating the substance from the fluid.

In certain embodiments, the invention relates to a method for separating a substance from a fluid, comprising the step of:

contacting with a fluid at a flow rate a porous polymeric particle made by any one of the aforementioned methods,

wherein

the fluid comprises a substance; and

the porous polymeric particle has an affinity for the substance, thereby separating the substance from the fluid.

### BRIEF DESCRIPTION OF THE DRAWINGS

FIG. 1 shows a scanning electron microscope (SEM) image of the pores of the particle of the present invention. Magnification is 10,000×. Polycarbonate dissolved in trichloromethane at 1 g polycarbonate per 10 ml trichloromethane. Sprayed with 120 kHz ultrasonic nozzle into liquid nitrogen. Vacuum flash dried for one hour. Average pore diameter of approximately 0.8 microns. Approximate surface porosity of 52%.

FIG. 2 shows a scanning electron microscope image of various porous particles of the present invention. Magnification is 350×. Polycarbonate dissolved in trichloromethane at 1 g polycarbonate per 10 ml trichloromethane. Sprayed with 120 kHz ultrasonic nozzle into liquid nitrogen. Vacuum flash dried for one hour. Particles are between 20 microns and 30 microns in approximate diameter.

FIG. 3 shows a scanning electron microscope image of a particle with a single large pore surrounded by multiple small pores. Magnification is 400×. Particle is approximately 200 microns in diameter. Such a particle will have positive flow characteristics with some feed streams due to the large pores maintaining flow and limited pressure drop while the retention through the bulk depth is determined by the multiple small pores.

FIG. 4 shows the basic steps of manufacturing the particle of the present invention. 1—Polymer and solvent mixing tank; 2—Nozzle delivery pump; 3—Spray nozzle; 4—Particle spray; 5—Cryogen container and frozen particle collection; 6—Frozen slurry delivery pump; 7—Vacuum tank or freeze dryer; 8—Vacuum pump; 9—Dried particle outlet; 10—Solvent and cryogen vapor exhaust.

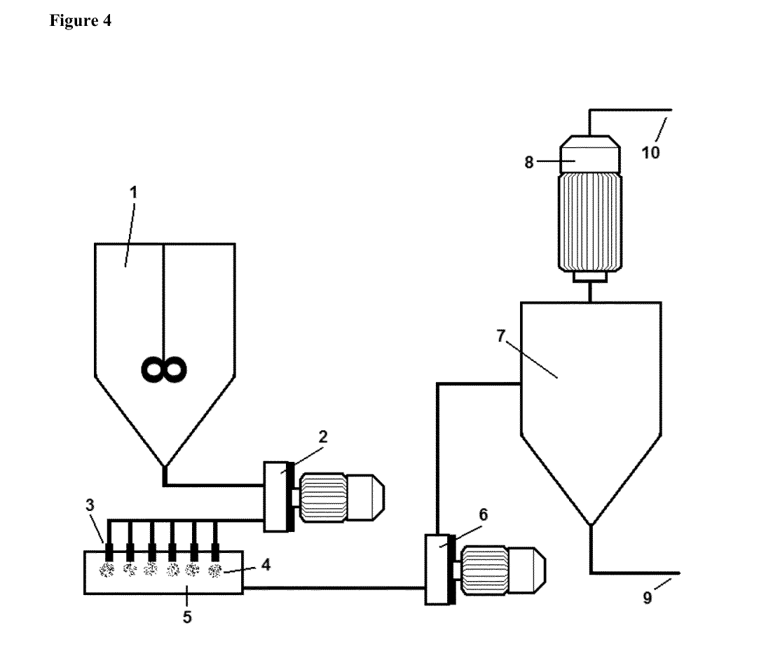

FIG. 5 depicts a schematic diagram of particles and their uses.

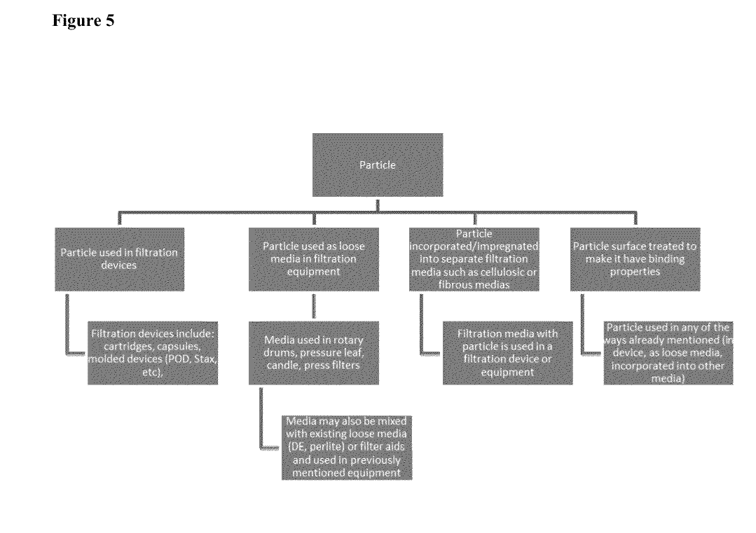

### DETAILED DESCRIPTION OF THE INVENTION

### Overview

In certain embodiments, the invention relates to the use of fine particle spraying into a freezing agent followed by either freeze or flash drying to create a porous polymeric particle that is used for the filtration or separation of contaminants or components from a fluid stream.

In certain embodiments, the invention solves a wide variety of problems with existing filtration media used in industry.

### Materials and Methods

In certain embodiments, a suitable polymer is first selected and dissolved in a suitable solvent. A suitable solvent is one that dissolves the polymer at the desired concentrations of both the polymer and the solvent and remains easily pumped and solids-free to avoid fouling and blocking of the spray nozzle 3. Polymer concentration can vary and will impact the size, porosity, and inner void volume of the particle. Polymer concentration will also impact the finished yield of the product and the speed at which the particle can be produced by the manufacturing process. The typical concentration will be less than 60% (wt. %) polymer.

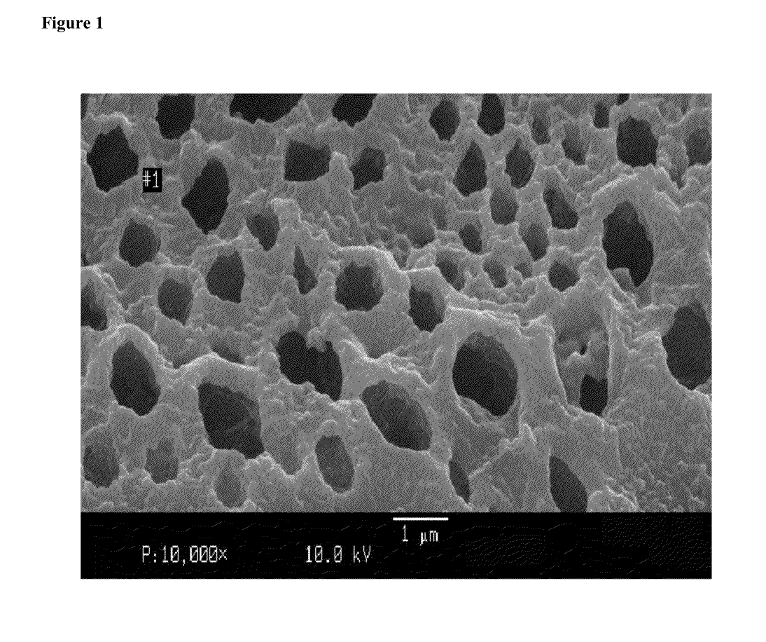

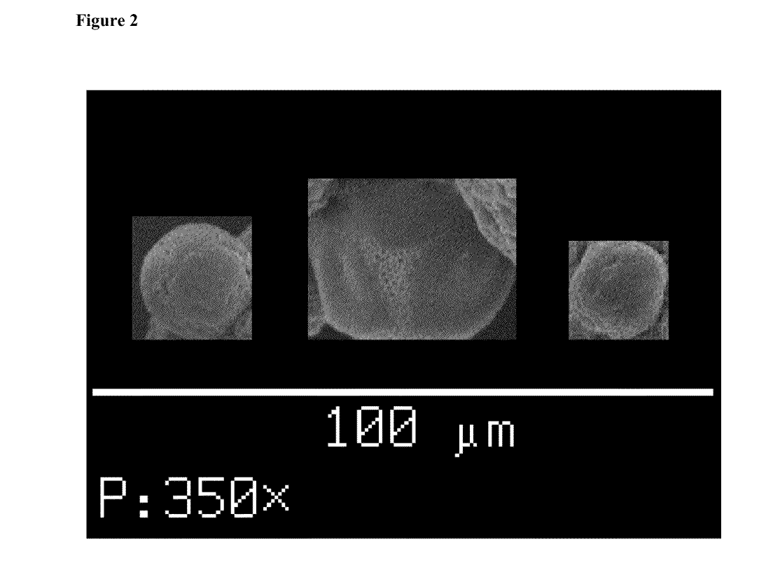

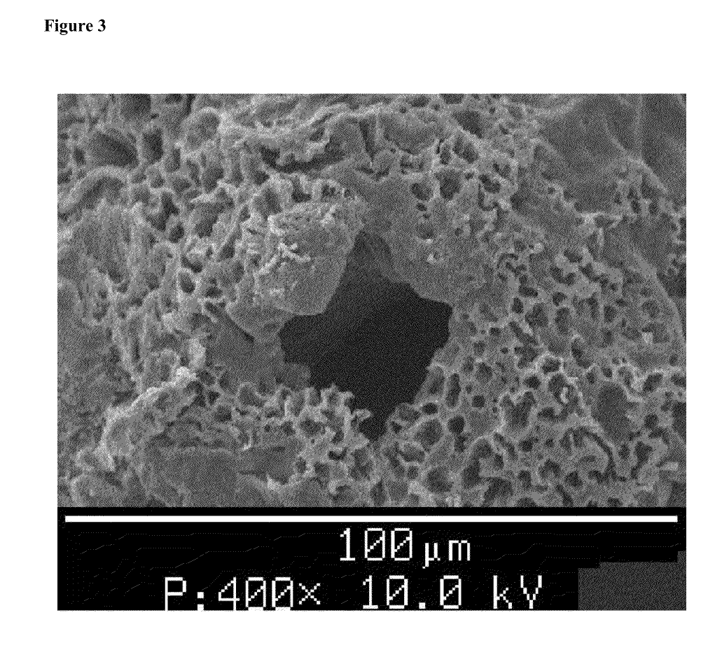

The polymer will typically be mixed under agitation in a tank 1 for some period of time after which the polymer is fully dissolved and the solution is homogenous. Particles shown in FIGS. 1, 2, and 3 were produced with a 6.75% (wt. %) polymer concentration (polycarbonate in trichloromethane). At this concentration for these components the polymer solvent mixing takes approximately 1.25 hrs with agitation for complete dissolution of polymer. Greater wt. % can be used with longer mixing times or with selection of polymers and solvents that provide for greater solubility of the selected polymer in the selected solvent.

A suitable solvent for polymers such as polycarbonate and polypropylene would include dichloromethane, xylene, or trichloromethane, for example, and are readily available and used in a wide variety of commercial applications. The solvent may vary based on the polymer and polymer concentration or the desired pore sizes and structure of the finished particle. A suitable polymer is chosen based on the filtration process requirements in which the particle will be used. In certain embodiments, the particle of the present invention is formed either entirely or predominantly of a polymeric composition such as polypropylene (PP); polyamide (PA); polyethylene terephthalate (PET); polysulfone (PS); polyethersulfone (PES); polyvinyl chloride (PVC), polycarbonate (PC), polyvinylidene fluoride (PVDF), polyetheretherketone (PEEK), polytetrafluoroethylene (PTFE), polyurethane (PU); polyethylene (including ultrahigh molecular weight polyethylene, linear low density polyethylene, ultralow, low, medium, high, or ultrahigh density polyethylene); ethylene vinyl alcohol (EVOH); polyvinyl acetate (PVA); ethylene vinyl acetate (EVA); ethylene vinyl acetate copolymers; cellulose and cellulose derived polymers; as well as other polymers and plastics (including thermoplastic polymers, thermoplastic elastomers, homopolymers, copolymers, block copolymers, graft copolymers, random copolymers, alternative copolymers, terpolymers, metallocene polymers, biopolymers) and derivatives or mixtures thereof.

The flow rate of fine particle generating nozzles is generally modest and so multiple nozzles 3 must be plumbed in series to create adequate flow for large-scale production of the present invention. Spray pattern should be optimized within the freezing chamber containing the freezing liquid. In certain embodiments, spray 4 is directed downwards towards the freezing fluid. Too tight of a spray pattern tends to increase agglomeration of the particles as they are frozen. A wider spray decreases tendency for agglomeration but increases atmospheric contact with the unfrozen particle that will cause evaporation of the solvent prior to the intended drying cycle.

In certain embodiments, a suitable pump 2 is used to transfer the polymer/solvent mixture to the spray nozzles 3, although ultrasonic nozzles may be gravity fed in some cases. High pressure pumps and transfer lines are required with some mechanical nozzles.

In certain embodiments, the size of the finished particle is predominantly determined by the type of spray nozzle 3 chosen and its parameters of operation. Ultrasonic nozzles can be used at low pressures to achieve very fine particle sizes as low as 10 microns. Ultrasonic nozzles require only an ultrasonic generator to be connected and turned on prior to the atomization of flow. The frequency of the ultrasonic nozzle determines the particle size with higher frequencies generally yielding smaller particles. The power setting of the ultrasonic generator also helps determine the particle size, efficiency of spray nozzle operation, and spray pattern. The power setting varies with each nozzle or frequency of nozzle and must be optimized for each feed stream on a particular nozzle. Typical power settings for ultrasonic nozzles will be set in 0.1 increments between 2 and 4.5 power units. Mechanical nozzles can be used to create the fine particle sizes of the present invention. While mechanical nozzles have not traditionally been used to create extremely fine particle sizes, new versions of mechanical nozzles released by many manufacturers in the past 5 years or so can achieve particle sizes as low or lower as those created with ultrasonic nozzles. Mechanical nozzles use a combination of pressure, flow, and nozzle structure, such as orifice size and design, to generate fine spray particles.

In certain embodiments, the spray of the nozzle 4 is directed towards a freezing source. In certain embodiments, the freezing source is one that is cryogenic such as liquid nitrogen to allow immediate freezing of the spray. The freezing creates a frozen particle of approximately the same size as the finished particle of the present invention. The cryogen will typically be held in a container or chamber 5 that encloses the system and is insulated to reduce cryogen evaporation.

In certain embodiments, the frozen slurry is transferred to a chamber 7 for solvent and cryogen removal (the drying process). In certain embodiments, transfer is accomplished by pump 6, conveyance, manual dumping, gravity feed, or other such method as required to transfer the frozen slurry to the drying step.

Freeze drying or lyophilization of materials is used to create, for example, pharmaceuticals or edible food products. Applying a stronger vacuum during the drying step allows for faster sublimation of volatile components in a mixture. This is sometimes referred to as “flash drying.” It should be noted that spray freeze drying and freeze drying are two completely different processes with separate applications.

In certain embodiments, the frozen polymeric particles are “flash dried.” In the present invention this can be used to generate a greater porosity and/or finer pores.

In certain embodiments, the drying process creates the pore structure and final size and shape of the particle. In one embodiment of the present invention, the frozen mixture can be transferred to a freeze drier or lyophilizer. In this embodiment, the chamber is usually pre-chilled to maintain freezing of the solvent while removing the cryogen. A vacuum is usually applied initially. The pressure can be from about 0.1 mbar to about 2 mbar. After a period of time the temperature of the chamber or inner components of the chamber, such as a drying shelf, is raised; either immediately or gradually, to remove the solvent by sublimation. Additional vacuum may also be applied. Freeze drying of this nature is widely used to create food products, enzymes, microbial products and so forth. Freeze drying or lyophilization generally allows for a slower and/or more gradual drying process as compared to flash drying.

In another embodiment of the present invention the frozen mixture is transferred to a chamber capable of withstanding high vacuum pressures. This is referred to herein as the vacuum flash approach. The vacuum chamber may be pre-chilled, at ambient temperature, or heated prior to and/or during the frozen slurry addition. In most embodiments frozen slurry containing an appreciable volume of cryogen is transferred. The cryogen present largely eliminates the need for pre-chilling the chamber and is contrasted with traditional freeze drying wherein the frozen material is often isolated from a cryogen or freezing source and so the chamber must be at a low initial temperature to avoid the melting of a pre-frozen material. In the case where the chamber is at ambient or an elevated temperature the cryogen and solvent begins to be removed more rapidly than during a traditional freeze drying process. A high vacuum typically between 1 mbar and 0.00001 mbar is applied with a suitable vacuum pump 8 and the cryogen quickly evaporates and the solvent sublimes rapidly. Increasing the chamber temperature during the initial fill step, vacuum step, or subsequent drying under vacuum step increases the rate at which the solvent sublimates and helps determine the pore structure. The entire process can be accomplished without the use of heat if a sufficient vacuum is applied quickly and thoroughly enough to sublimate the solvent without allowing the solvent to melt. The pump 8 must also maintain sufficient flow, in addition to maximum end vacuum pressure, due to the evaporating cryogen and sublimating solvent. The additional gas volume created by the evaporating cryogen and sublimating solvent will increase the pressure if it is not removed quickly enough. This reduces the vacuum.

In certain embodiments, care should be taken to avoid premature evaporation of solvent or melting of frozen polymeric particles. The solvents used will be highly volatile and prove relatively easy to sublimate under vacuum. In certain embodiments, the vacuum flash method typically results in a greater number of smaller pores although it is reasoned that optimizing parameters should allow for comparable results by way of freeze drying or lyophilization, with the exception that the vacuum flash method would almost certainly always result in a faster drying time and thereby quicker production. In certain embodiments, the vacuum flash method is significantly quicker, taking less than one hour for complete drying at ambient temperature (without additional heating at any point in the drying process) compared with freeze drying that can sometimes take several hours or more for complete drying. Various equipment can be constructed by those with basic knowledge in the relevant art that incorporates one or more or a combination of methods of drying previously discussed herein.

Both previously disclosed embodiments involve a drying chamber 7 that is closed during drying under a vacuum, allowing the solvent to be readily reclaimed and condensed in a high purity and recycled for future use 10. The most obvious cryogen, liquid nitrogen, is easily sourced by tanker at a low cost or can be generated on-site. Drying parameters can be changed to modify the size of the particle, the shape of the particle, the overall porosity of the particle, and the size of the pores. Such parameters include the initial temperature of the chamber, the vacuum applied, internal components of the chamber such as drying shelves, primary and secondary drying times, temperature changes during drying, as well as the thickness and/or volume of frozen slurry to be dried. If the particle is frozen and dried with minimal agglomeration the finished particle will be relatively free-flowing and can be removed from the chamber 9 by common powder transfer methods. Particles formed with modest or heavy agglomeration can be milled to the desired particle size and consistency while maintaining pore and most particle shape characteristics post-milling.

In one embodiment, the particle of the present invention is used in loose media filtration equipment as an alternative to diatomaceous earth using the same basic methods currently in use. Such equipment includes pressure leaf, rotary drum, candle, or press filters. Typically, slurry containing the particle is mixed and pumped to the filtration equipment to create a cake of filter media on an internal structure such as a candle, leaf, drum, or screen. This is often referred to as the pre-coat. Various filter aids may be added to improve filter or cake performance. The fluid to be processed is then fed through the filter media and supporting device. Additional media is continuously added during the filtration run to maintain filtration capacity. The separation of components occurs as the fluid passes through the media. In smaller scale processes the present invention may also be used in any general vessel that provides a container for the media and flow through the container for the fluid to be processed. The amount of media (present invention) used is dependent on the particle characteristics, filtration equipment and size, filter aids or additives, and operating parameters of the filtration process. A reasonable amount of pre-coat for a 15 micron (approximate median diameter) polymeric particle with 50% surface porosity might be 5 to 25 lbs per 100 sq ft of filter surface area in a pressure leaf filter, for example.

In another embodiment the particle of the present invention is incorporated into filtration devices such as capsules, cartridges, stacks, and molded devices to be used in process for the filtration and separations of materials from fluid streams. The particle may still be regarded as a loose powder media within such a device. There are clear differences between filtration devices such as capsules, cassettes, cartridges, molded devices, and so forth and loose media filtration equipment such as pressure leaf and candle filters that are understood to those familiar with the art. The filtration device containing the present invention may, itself, be part of larger equipment such as a filter holder or housing. Examples of molded filtration devices include POD from EMD Millipore, Stax from Pall, or L-Drum from Sartorius Stedim. The use of filtration devices is widespread within various industries although the more disposable formats such as the POD, Stax and L-Drum previously named are almost exclusively used in biopharmaceutical processes for post-bioreactor clarification of fluid streams.

In another embodiment the particle of the present invention is incorporated or impregnated into any existing filter media or filtration support media such that the filtration or separation characteristics of the existing media are enhanced by the presence of the particle of the present invention. Current filtration media composed of spun or wound fibers as well as cellulosic or lenticular filter media are often impregnated with diatomaceous earth. Due to the inherent issues with diatomaceous earth, many of which limit its use in existing filtration media, the particle of the present invention may be substituted to create a more advantageous filtration or separations media. Diatomaceous earth is typically impregnated at a concentration of approximately 5 wt. % total media. The particle of the present invention may be used in greater concentrations than diatomaceous earth to offer greater filtration capacity in spun or wound fiber filters or cellulose-based filtration media and could comprise as much as 50%, total media wt. %.

In another embodiment the particle of the present invention may be surface treated prior to use as a loose media, incorporation into a filter device, or impregnation into a filter media or support such that the surface treatment adds or enhances its filtration or separations performance. An example would be the cross-linking of a primary amine onto the particle of present invention that was created with an acceptable polymer such as ultra-high molecular weight polyethylene. The particle would first be created and then a surface treatment solution would be applied. Such a solution will typically have the primary amine component (between 1 and 20 wt. %), a hydrophilization polymer (between 0.1 to 5 wt. %), as well as a cross-linking agent (between 0.1 and 5 wt. %) and a nominal wt % of a surfactant to promote even distribution. The media of this example would perform both a size exclusion filtration as well as an anion exchange separation of contaminants such as virus, DNA, or host cell protein. The surface treatment of membranes and polymers is commonplace and well documented in the literature with such techniques including coating, grafting, chemical oxidation, ligand binding, plasma treating, and crosslinking. The particle, once treated, will still be used in processes as previous described; as a loose media, incorporated into a filtration device, or impregnated into a separate material. In this embodiment the particle of the present invention may be used as a loose media packed into a chromatography column or other flow through chamber or bed.

### Properties of the Polymeric Particles

One of the most widely used filtration media currently in use is the solvent cast, immersion precipitated, or phase separated polymeric sheet. Each of these methods produces a similar porous polymeric sheet. The primary drawback of this media is that it is made as thin sheets and has extremely low filtration capacity. In addition, cast membrane sheets cannot be stacked to create any significant depth due to their flow mechanics, effective surface area, and tendencies to become blocked.

In certain embodiments, filtration and separations media used in the pharmaceutical and biotechnology fields are used in single use formats that involve enclosed media. In certain embodiments, the media is housed within a molded device.

In certain embodiments, filtration devices used in the pharmaceutical and biotechnology fields are sold and used pre-sterilized. In certain embodiments, gamma irradiation is the standard for pre-sterilized equipment and devices. Many materials currently used as filtration media within such devices are not gamma compatible.

In certain embodiments, the invention relates to polymeric particles that are gamma-compatible. In certain embodiments, the gamma-compatible polymer is polycarbonate. In certain embodiments, the invention relates to polymeric particles that may be sterilized prior to use by electron beam irradiation, exposure to ethylene dioxide, or autoclaving. In certain embodiments, the invention relates to polymeric particles that are compatible with in-process sterilization techniques such as steaming, hot water, caustic, or the use of chemicals.

Centrifugation is used by a large portion of pharmaceutical and biotechnology processes to separate bulk solids and cell debris following the fermentation or bioreactor step. Centrifugation is used because no compact and product-safe filtration media currently in use has a capacity and performance high enough to substitute for centrifugation in processes of any appreciable scale. In certain embodiments, the present invention has the capacity, cost, and ability to be used in lieu of centrifugation to offer a true filtration stage post-fermentation. The performance of the present invention would also eliminate or limit the need for problematic processes such as acid precipitation or flocculation, which are sometimes used in conjunction with centrifuges or traditional filtration media.

Extractable and leachable contaminants are of important concern to pharmaceutical and biotechnology companies. Such contaminants are present as a result of the materials and fluid contact surfaces used in a process. All new materials used in a process are tested for extractables and leachables and the total amount of extractables and leachables for a process must be controlled. One reason diatomaceous earth is not used in any appreciable amount in pharmaceutical processes is due to it being high in extractable and leachable content. In certain embodiments, the present invention offers a significantly lower amount of extractables and leachables per filtration capacity than most current media employed in post-fermentation or bioreactor clarification of fluid streams. Also, since the present invention may be constructed with polymers common to industry, the associated extractables and leachables are of a consistent and expected nature as compared to other industry components. It is also easily processed, flushed, or cleaned in various ways to minimize the extractables and leachables in the finished media product.

Filter devices used in the pharmaceutical and biotechnology fields are extremely expensive, often priced greater than 1,000 USD per single low capacity device. In certain embodiments, the media of the current invention may be produced at a cost hundreds of times less than current filtration media. In certain embodiments, media composed of the particle of the present invention can be produced for as little as 0.45 USD per kg.

One of the largest drawbacks of diatomaceous earth used in beverage filtration is its high liquid retention. In many processes 680 grams (1.5 lbs.) of liquid is retained per every 454 grams (1 lb.) of diatomaceous earth used, even with recovery steps. The lost liquid may be worth more than the filter media itself, depending on the feed stream. The largest processors may lose millions of dollars in product annually. In certain embodiments, the present invention makes use of polymers that are naturally slightly hydrophobic, such as polypropylene. This allows for much more complete draining of liquid from the filtration equipment resulting in a dry filter media and greater process recovery. Dry filter media is less expensive to dispose of and has less environmental impact due to evaporating volatile components, such as alcohols.

Diatomaceous earth is considered a carcinogen and requires special handling and delivery systems to use. Inert polymers used in the present invention require no such procedures or equipment and offers a safer alternative to employees and employers. Green processing and recycling is increasingly important to all processors. Current filtration media and devices are often a mixture of materials that cannot be recycled at all or cannot be recycled easily in their entirety. Disposal of diatomaceous earth wetted with process fluid is of particular concern and is increasingly being regulated by many countries, particularly in Europe, and has a significant cost. In certain embodiments, the particles of the invention may be easily recycled because they can be made entirely of a single and commonly recycled polymer such as polypropylene. In certain embodiments, the particles may also be incinerated on-site for disposal, such as when the polymer is not easily recycled or when the present invention is composed of two or more polymers.

Flat sheet membrane chromatography devices are extremely size limited and are currently only used in small processes or applications. In certain embodiments, applying a surface treatment to the present invention to create an adsorptive or binding capable material provides a better alternative to current membrane absorbers capable of being used in larger scale processes at a considerably lower cost.

### Exemplary Polymeric Particles

In certain embodiments, the invention relates to a porous polymeric particle, wherein the porous polymeric particle

comprises a plurality of pores; and

comprises a polymer is selected from the group consisting of thermoplastic polymers, thermoplastic elastomers, homopolymers, copolymers, block copolymers, graft copolymers, random copolymers, alternative copolymers, terpolymers, biopolymers, and metallocene polymers, and derivatives or mixtures thereof.

In certain embodiments, the invention relates to a porous polymeric particle, wherein the porous polymeric particle

comprises a plurality of pores; and

comprises a polymer selected from the group consisting of polypropylene (PP), polyamide (PA), polyethylene terephthalate (PET), polysulfone (PS), polyethersulfone (PES), polyvinyl chloride (PVC), polycarbonate (PC), polyvinylidene fluoride (PVDF), polyetheretherketone (PEEK), polytetrafluoroethylene (PTFE), polyurethane (PU), polyethylene (including ultrahigh molecular weight polyethylene, linear low density polyethylene, ultralow, low, medium, high, or ultrahigh density polyethylene), ethylene vinyl alcohol (EVOH), polyvinyl acetate (PVA), ethylene vinyl acetate (EVA), ethylene vinyl acetate copolymers, and cellulose and cellulose derived polymers, and copolymers or mixtures thereof.

In certain embodiments, the invention relates to any one of the aforementioned porous polymeric particles, wherein the porous polymeric particle is substantially spherical in shape.

In certain embodiments, the invention relates to any one of the aforementioned porous polymeric particles, wherein the porous polymeric particle has a surface porosity of between about 5% and about 95%. In certain embodiments, the invention relates to any one of the aforementioned porous polymeric particles, wherein the porous polymeric particle has a surface porosity of about 10%, about 15%, about 20%, about 25%, about 30%, about 35%, about 40%, about 45%, about 50%, about 55%, about 60%, about 65%, about 70%, about 75%, about 80%, about 85%, or about 90%.

In certain embodiments, the invention relates to any one of the aforementioned porous polymeric particles, wherein the porous polymeric particle is between about 0.05 microns to about 1,000 microns in diameter. In certain embodiments, the invention relates to any one of the aforementioned porous polymeric particles, wherein the porous polymeric particle is between about 5 microns to about 60 microns in diameter. In certain embodiments, the invention relates to any one of the aforementioned porous polymeric particles, wherein the porous polymeric particle has a diameter of about 0.1 microns, about 0.2 microns, about 0.3 microns, about 0.4 microns, about 0.5 microns, about 1 micron, about 2 microns, about 3 microns, about 4 microns, about 5 microns, about 10 microns, about 15 microns, about 20 microns, about 25 microns, about 30 microns, about 35 microns, about 40 microns, about 45 microns, about 50 microns, about 55 microns, about 60 microns, about 65 microns, about 70 microns, about 75 microns, about 80 microns, about 85 microns, about 90 microns, about 95 microns, about 100 microns, about 125 microns, about 150 microns, about 175 microns, about 200 microns, about 225 microns, about 250 microns, about 275 microns, about 300 microns, about 350 microns, about 400 microns, about 450 microns, about 500 microns, about 550 microns, about 600 microns, about 650 microns, about 700 microns, about 750 microns, about 800 microns, about 850 microns, about 900 microns, about 950 microns, or about 1000 microns.

In certain embodiments, the size of the particle itself has important implications on the flow mechanics of the processes. Smaller particles increase the surface area available and thereby the process efficiency, however, the pressure drop of the process will also be increased. Larger particles will decrease the pressure drop. Increasing efficiency (small particles) generally lowers the amount of media required; however, so does decreasing pressure drop (large particles).

In certain embodiments, the invention relates to any one of the aforementioned porous polymer particles, wherein the porous polymeric particle comprises a plurality of pores; and each pore is from about 0.01 microns to about 100 microns in diameter. In certain embodiments, the invention relates to any one of the aforementioned porous polymer particles, wherein the porous polymeric particle comprises a plurality of pores; and the average pore size in the particle is from about 0.01 microns to about 100 microns in diameter. In certain embodiments, the invention relates to any one of the aforementioned porous polymer particles, wherein the porous polymeric particle comprises a plurality of pores; and each pore is from about 0.1 microns to about 2 microns in diameter. In certain embodiments, the invention relates to any one of the aforementioned porous polymer particles, wherein the porous polymeric particle comprises a plurality of pores; and the average pore size in the particle is from about 0.1 microns to about 2 microns in diameter. In certain embodiments, the invention relates to any one of the aforementioned porous polymer particles, wherein the porous polymeric particle comprises a plurality of pores; and each pore has a diameter of about 0.01 microns, about 0.02 microns, about 0.03 microns, about 0.04 microns, about 0.05 microns, about 0.1 microns, about 0.2 microns, about 0.3 microns, about 0.4 microns, about 0.5 microns, about 1 micron, about 2 microns, about 3 microns, about 4 microns, about 5 microns, about 6 microns, about 7 microns, about 8 microns, about 9 microns, or about 10 microns. In certain embodiments, the invention relates to any one of the aforementioned porous polymer particles, wherein the porous polymeric particle comprises a plurality of pores; and the average pore size in the particle is about 0.01 microns, about 0.02 microns, about 0.03 microns, about 0.04 microns, about 0.05 microns, about 0.1 microns, about 0.2 microns, about 0.3 microns, about 0.4 microns, about 0.5 microns, about 1 micron, about 2 microns, about 3 microns, about 4 microns, about 5 microns, about 6 microns, about 7 microns, about 8 microns, about 9 microns, or about 10 microns in diameter.

In certain embodiments, the pore size of the particle primarily determines removal retention and efficiency. Particle size, porosity and pore size must be harmonized to create the best balance for a particular process or application.

In certain embodiments, the invention relates to any one of the aforementioned porous polymer particles, wherein the each of the plurality of pores has a smaller diameter than the diameter of the porous polymeric particle.

In certain embodiments, the invention relates to any one of the aforementioned porous polymer particles, wherein the porous polymeric particle has an affinity for a substance.

In certain embodiments, the invention relates to any one of the aforementioned porous polymer particles, wherein the porous polymeric particle is positively or negatively charged.

In certain embodiments, the invention relates to any one of the aforementioned porous polymer particles, further comprising a ligand covalently or non-covalently bound to the surface of the porous polymeric particle.

In certain embodiments, the invention relates to any one of the aforementioned porous polymer particles for use in the separation of a substance from a fluid.

In certain embodiments, the invention relates to a porous polymeric particle made by any one of the methods mentioned below.

### Exemplary Methods

In certain embodiments, the invention relates to a method of forming a plurality of porous polymeric particles comprising the steps of

contacting a polymer in a solvent, thereby creating a solution;

spraying the solution from a nozzle into a container, thereby creating a plurality of particles;

subjecting the plurality of particles to a first temperature, wherein the first temperature is less than about 15° C., thereby forming a plurality of frozen particles; and

removing substantially all of the solvent from the plurality of frozen particles, thereby forming a plurality of porous polymeric particles.

In certain embodiments, the invention relates to any one of the aforementioned methods, wherein the porous polymeric particle is used for the separation of a substance from a fluid.

In certain embodiments, the invention relates to any one of the aforementioned methods, wherein the porous polymeric particle is any one of the aforementioned porous polymeric particles.

In certain embodiments, the invention relates to any one of the aforementioned methods, wherein the polymer is selected from the group consisting of thermoplastic polymers, thermoplastic elastomers, homopolymers, copolymers, block copolymers, graft copolymers, random copolymers, alternative copolymers, terpolymers, biopolymers, and metallocene polymers, and derivatives or mixtures thereof.

In certain embodiments, the invention relates to any one of the aforementioned methods, wherein the polymer is selected from the group consisting of polypropylene (PP), polyamide (PA), polyethylene terephthalate (PET), polysulfone (PS), polyethersulfone (PES), polyvinyl chloride (PVC), polycarbonate (PC), polyvinylidene fluoride (PVDF), polyetheretherketone (PEEK), polytetrafluoroethylene (PTFE), polyurethane (PU), polyethylene (including ultrahigh molecular weight polyethylene, linear low density polyethylene, ultralow, low, medium, high, or ultrahigh density polyethylene), ethylene vinyl alcohol (EVOH), polyvinyl acetate (PVA), ethylene vinyl acetate (EVA), ethylene vinyl acetate copolymers, and cellulose and cellulose derived polymers, and copolymers or mixtures thereof.

In certain embodiments, the invention relates to any one of the aforementioned methods, wherein the polymer is selected from the group consisting of polypropylene (PP) and polycarbonate (PC).

In certain embodiments, the invention relates to any one of the aforementioned methods, wherein the polymer is substantially soluble in the solvent.

In certain embodiments, the invention relates to any one of the aforementioned methods, wherein the solvent is selected from the group consisting of dichloromethane, 1,1-dichloroethane, xylene, toluene, acetone, and trichloromethane, and combinations or mixtures thereof.

In certain embodiments, the invention relates to any one of the aforementioned methods, wherein the solvent is trichloromethane.

In certain embodiments, the invention relates to any one of the aforementioned methods, wherein the concentration of the polymer in the solvent is from about 0.01 wt % to about 60 wt %. In certain embodiments, the invention relates to any one of the aforementioned methods, wherein the concentration of the polymer in the solvent is from about 1 wt % to about 20 wt %. In certain embodiments, the invention relates to any one of the aforementioned methods, wherein the concentration of the polymer in the solvent is about 0.01 wt %, about 0.05 wt %, about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, or about 20 wt %.

In certain embodiments, the invention relates to any one of the aforementioned methods, further comprising the step of mixing the polymer and the solvent for a first amount of time.

In certain embodiments, the invention relates to any one of the aforementioned methods, the first amount of time is from about 5 min to about 2 d. In certain embodiments, the invention relates to any one of the aforementioned methods, the first amount of time is about 5 min, about 10 min, about 20 min, about 30 min, about 40 min, about 50 min, about 60 min, about 70 min, about 80 min, about 90 min, about 100 min, about 110 min, about 120 min, about 130 min, about 140 min, about 150 min, about 160 min, about 170 min, about 180 min, about 4 h, about 5 h, about 10 h, about 15 h, about 20 h, about 1 d, or about 2 d.

In certain embodiments, the invention relates to any one of the aforementioned methods, wherein the nozzle is an ultrasonic spray nozzle.

In certain embodiments, the invention relates to any one of the aforementioned methods, wherein the ultrasonic spray nozzle is operated at a frequency. In certain embodiments, the invention relates to any one of the aforementioned methods, wherein the frequency is from about 20 kHz to about 200 MHz. In certain embodiments, the invention relates to any one of the aforementioned methods, wherein the frequency is from about 20 kHz to about 200 kHz. In certain embodiments, the invention relates to any one of the aforementioned methods, wherein the frequency is about 20 kHz, about 30 kHz, about 40 kHz, about 50 kHz, about 60 kHz, about 70 kHz, about 80 kHz, about 90 kHz, about 100 kHz, about 110 kHz, about 120 kHz, about 130 kHz, about 140 kHz, about 150 kHz, about 160 kHz, about 170 kHz, about 180 kHz, about 190 kHz, or about 200 kHz.

In certain embodiments, the invention relates to any one of the aforementioned methods, wherein the nozzle is a mechanical spray nozzle.

In certain embodiments, the invention relates to any one of the aforementioned methods, wherein a combination of two or more polymers is dissolved in the solvent.

In certain embodiments, the invention relates to any one of the aforementioned methods, wherein the solvent comprises a first solvent and a second solvent.

In certain embodiments, the invention relates to any one of the aforementioned methods, wherein the solvent comprises three or more solvents.

In certain embodiments, the invention relates to any one of the aforementioned methods, wherein the first temperature is from about −200° C. to about 15° C. In certain embodiments, the invention relates to any one of the aforementioned methods, wherein the first temperature is less than about 10° C. In certain embodiments, the invention relates to any one of the aforementioned methods, wherein the first temperature is about −200° C., about −195° C., about −190° C., about −185° C., about −180° C., about −175° C., about −170° C., about −165° C., about −160° C., about −155° C., about −150° C., about −145° C., about −140° C., about −135° C., about −130° C., about −125° C., about −120° C., about −115° C., about −110° C., about −105° C., about −100° C., about −95° C., about −90° C., about −85° C., about −80° C., about −75° C., about −70° C., about −65° C., about −60° C., about −55° C., about −50° C., about −45° C., about −40° C., about −35° C., about −30° C., about −25° C., about −20° C., about −15° C., about −10° C., about −5° C., about 0° C., about 5° C., or about 10° C.

In certain embodiments, the invention relates to any one of the aforementioned methods, wherein the plurality of particles are subject to the first temperature inside the container.

In certain embodiments, the invention relates to any one of the aforementioned methods, wherein the container comprises a cryogenic fluid or a freezing fluid.

In certain embodiments, the invention relates to any one of the aforementioned methods, wherein the solution is sprayed into a freezing fluid, thereby forming a plurality of frozen particles.

In certain embodiments, the invention relates to any one of the aforementioned methods, wherein the plurality of particles contact the freezing fluid, thereby forming a plurality of frozen particles.

In certain embodiments, the invention relates to any one of the aforementioned methods, wherein the container comprises a cryogenic fluid or a freezing fluid.

In certain embodiments, the invention relates to any one of the aforementioned methods, wherein the cryogenic fluid is a liquefied gas.

In certain embodiments, the invention relates to any one of the aforementioned methods, wherein the cryogenic fluid is liquid nitrogen.

In certain embodiments, the invention relates to any one of the aforementioned methods, wherein the plurality of particles contact a gas generated by the cryogenic fluid.

In certain embodiments, the invention relates to any one of the aforementioned methods, wherein the plurality of frozen particles is subject to vacuum pressure for a second amount of time, thereby removing substantially all of the solvent from the plurality of frozen particles.

In certain embodiments, the invention relates to any one of the aforementioned methods, wherein the vacuum pressure is from about 1000 mbar to about 1×10⁻¹⁰ mbar. In certain embodiments, the invention relates to any one of the aforementioned methods, wherein the vacuum pressure is from about 10 mbar to about 0.0001 mbar. In certain embodiments, the invention relates to any one of the aforementioned methods, wherein the vacuum pressure is about 2 mbar, about 1.9 mbar, about 1.8 mbar, about 1.7 mbar, about 1.6 mbar, about 1.5 mbar, about 1.4 mbar, about 1.3 mbar, about 1.2 mbar, about 1.1 mbar, about 1 mbar, about 0.9 mbar, about 0.8 mbar, about 0.7 mbar, about 0.6 mbar, about 0.5 mbar, about 0.4 mbar, about 0.3 mbar, about 0.2 mbar, about 0.1 mbar, about 0.09 mbar, about 0.08 mbar, about 0.07 mbar, about 0.06 mbar, about 0.05 mbar, about 0.04 mbar, about 0.03 mbar, about 0.02 mbar, about 0.01 mbar, about 0.005 mbar, about 0.001 mbar, about 0.0005 mbar, about 0.0001 mbar, about 0.00005 mbar, or about 0.00001 mbar.

In certain embodiments, the invention relates to any one of the aforementioned methods, further comprising the step of: removing substantially all of the cryogenic fluid or the freezing fluid from the plurality of frozen particles.

In certain embodiments, the invention relates to any one of the aforementioned methods, wherein the plurality of frozen particles is subject to a second temperature for a second amount of time, thereby removing substantially all of cryogenic fluid, the freezing fluid, or the solvent from the plurality of frozen particles.

In certain embodiments, the second temperature is merely the warming of the chamber upon evaporation of the cryogenic fluid.

In certain embodiments, the invention relates to any one of the aforementioned methods, wherein the second temperature is from about −200° C. to about 200° C. In certain embodiments, the invention relates to any one of the aforementioned methods, wherein the second temperature is about −200° C., about −175° C., about −150° C., about −125° C., about −100° C., about −75° C., about −50° C., about −25° C., about 0° C., about 25° C., about 50° C., about 75° C., about 100° C., about 125° C., about 150° C., about 175° C., or about 200° C.

In certain embodiments, the cryogenic fluid or freezing fluid is removed by holding at the second temperature. In certain embodiments, the second temperature is about −200° C. In certain embodiments, this step is completed in an uninsulated chamber or tank. In certain embodiments, once the cryogenic fluid or freezing fluid is removed, the solvent is then removed. In certain embodiments, the solvent is removed by sublimation. In certain embodiments, the solvent is removed by flash drying. In certain embodiments, the solvent is removed by contacting the plurality of particles with steam.

In certain embodiments, the invention relates to any one of the aforementioned methods, wherein the plurality of frozen particles is subject to vacuum pressure and a second temperature for a second amount of time, thereby removing substantially all of the solvent from the plurality of frozen particles. Some freeze dryers work by increasing temperature or vacuum several times during the drying step, so further temperature and further amounts of time are required. For example, the second temperature and the second pressure and a second amount of time may be used to remove the cryogenic fluid, a third temperature and a third pressure and a third amount of time may then be used to remove the solvent, or a fourth temperature and a fourth pressure and a fourth amount of time may then be used to remove any water vapor or additional solvent.

In certain embodiments, the invention relates to any one of the aforementioned methods, wherein substantially all of the solvent is removed by sublimation.

In certain embodiments, the invention relates to any one of the aforementioned methods, wherein the second amount of time is from about 5 min to about 2 d. In certain embodiments, the invention relates to any one of the aforementioned methods, wherein the second amount of time is about 10 min, about 20 min, about 30 min, about 40 min, about 50 min, about 60 ml, about 70 min, about 80 min, about 90 min, about 100 min, about 110 min, about 120 min, about 3 h, about 4 h, about 5 h, about 10 h, about 15 h, about 20 h, about 1 d, or about 2 d.

In certain embodiments, the invention relates to any one of the aforementioned methods, wherein the solvent is removed from the plurality of frozen particles by sublimation or evaporation.

In certain embodiments, the invention relates to any one of the aforementioned methods, wherein the solvent is removed from the plurality of frozen particles by sublimation.

In certain embodiments, the invention relates to any one of the aforementioned methods, further comprising the step of transferring the plurality of frozen particles to a drying chamber.

In certain embodiments, the invention relates to any one of the aforementioned methods, wherein the plurality of frozen particles is transferred to the drying chamber by gravity.

In certain embodiments, the invention relates to any one of the aforementioned methods, wherein the plurality of frozen particles is mechanically pumped, conveyed, or dumped into the drying chamber.

In certain embodiments, the invention relates to any one of the aforementioned methods, further comprising the step of sterilizing the plurality of porous polymeric particles.

In certain embodiments, the invention relates to any one of the aforementioned methods, wherein the plurality of porous polymeric particles are gamma irradiated, electron beam irradiated, autoclaved, or exposed to ethylene oxide.

In certain embodiments, the invention relates to any one of the aforementioned methods, further comprising the step of modifying the surfaces of the plurality of porous polymeric particles.

In certain embodiments, the invention relates to any one of the aforementioned methods, wherein the surface treating is selected from the group consisting of coating, grafting, chemical oxidation, ligand binding, plasma treating, and crosslinking

### Exemplary Filtration or Separation Media

In certain embodiments, the invention relates to a filtration or separation medium, wherein the filtration or separation medium comprises a plurality of any of the aforementioned porous polymeric particles.

In certain embodiments, the invention relates to any one of the aforementioned filtration or separation media, further comprising diatomaceous earth, cellulosic materials, perlite, or a different fibrous filtration medium.

### Exemplary Devices and Equipment

In certain embodiments, the invention relates to a device, wherein the device comprises a plurality of any of the aforementioned porous polymeric particles.

In certain embodiments, the invention relates to any one of the aforementioned devices, wherein the device is a cartridge, cassette, stack, capsule, or molded device.

In certain embodiments, the invention relates to any one of the aforementioned devices, wherein the device is used for filtration or separation of a substance from a fluid.

In certain embodiments, the invention relates to any one of the aforementioned devices, wherein the device comprises any one of the aforementioned filtration or separation media.

In certain embodiments, the invention relates to any one of the aforementioned devices, wherein the device has a low volume format.

In certain embodiments, the invention relates to any one of the aforementioned devices, wherein the device is disposable.

In certain embodiments, the invention relates to any one of the aforementioned devices, further comprising the step of sterilizing the device.

In certain embodiments, the invention relates to any one of the aforementioned devices, wherein the device is gamma irradiated, electron beam irradiated, autoclaved, or exposed to ethylene oxide.

In certain embodiments, the invention relates to any one of the aforementioned devices, wherein the device is in a single use format.

In certain embodiments, the invention relates to filtration equipment, wherein the filtration equipment comprises any of the aforementioned porous polymeric particles.

In certain embodiments, the invention relates to any one of the aforementioned filtration equipment, wherein the filtration equipment is a rotary vacuum, pressure leaf, press, or candle filter.

### Exemplary Methods of Use

In certain embodiments, the invention relates to a method for separating a substance from a fluid, comprising the step of:

contacting with a fluid at a flow rate any one of the aforementioned porous polymeric particles,

wherein

the fluid comprises a substance; and

the pores of the porous polymeric particles are of sufficient size to substantially trap the substance, thereby separating the substance from the fluid.

In certain embodiments, the invention relates to a method for separating a substance from a fluid, comprising the step of:

contacting with a fluid at a flow rate any one of the aforementioned porous polymeric particles,

wherein

the fluid comprises a substance; and

the porous polymeric particles has an affinity for the substance, thereby separating the substance from the fluid.

### EXEMPLIFICATION

The following examples are provided to illustrate the invention. It will be understood, however, that the specific details given in each example have been selected for purpose of illustration and are not to be construed as limiting the scope of the invention. Generally, the experiments were conducted under similar conditions unless noted.

### Example 1

Polycarbonate dissolved in trichloromethane at 1 g polycarbonate per 10 mL trichloromethane. Sprayed with 120 kHz ultrasonic nozzle into liquid nitrogen. Vacuum flash dried for one hour. Average pore size of approximately 0.8 microns. Approximate surface porosity of 52%. Particles are between 20 microns and 30 microns in approximate diameter.

All measurements were estimated from SEM images. The images were obtained while the microscope was at normal room temperature (about 20° C. to about 25° C.) and atmosphere but the images were taken in the SEM chamber at an operating vacuum of around 2×10⁻⁶ torr.

### INCORPORATION BY REFERENCE

All of the U.S. patents and U.S. published patent applications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

I claim:

1. A filtration or separation medium, wherein
the filtration or separation medium comprises a plurality of porous polymeric particles;
the porous polymeric particle comprises a plurality of pores; and
the porous polymeric particle comprises a polymer selected from the group consisting of thermoplastic polymers, thermoplastic elastomers, homopolymers, copolymers, block copolymers, graft copolymers, random copolymers, alternative copolymers, terpolymers, biopolymers, and metallocene polymers, and derivatives or mixtures thereof.

2. The filtration or separation medium of claim 1, wherein the polymer is selected from the group consisting of polypropylene, polyamide, polyethylene terephthalate, polysulfone, polyethersulfone, polyvinyl chloride, polycarbonate, polyvinylidene fluoride, polyetheretherketone, polytetrafluoroethylene, polyurethane, polyethylene, ethylene vinyl alcohol, polyvinyl acetate, ethylene vinyl acetate, ethylene vinyl acetate copolymers, and cellulose and cellulose derived polymers, and copolymers and mixtures thereof.

3. The filtration or separation medium of claim 1, further comprising diatomaceous earth, cellulosic materials, perlite, or a different fibrous filtration medium.

4. The filtration or separation medium of claim 1, wherein the porous polymeric particle is substantially spherical in shape.

5. The filtration or separation medium of claim 1, wherein the porous polymeric particle has a surface porosity of between about 5% and about 95%.

6. The filtration or separation medium of claim 1, wherein the porous polymeric particle is between about 0.05 microns to about 1,000 microns in diameter.

7. The filtration or separation medium of claim 1, wherein the porous polymeric particle is between about 5 microns to about 60 microns in diameter.

8. The filtration or separation medium of claim 1, wherein the porous polymeric particle comprises a plurality of pores; and the average pore size in the particle is from about 0.01 microns to about 100 microns in diameter.

9. The filtration or separation medium of claim 1, wherein the porous polymeric particle comprises a plurality of pores; and the average pore size in the particle is from about 0.1 microns to about 2 microns in diameter.

10. The filtration or separation medium of claim 1, wherein the porous polymeric particle has an affinity for a substance.

11. The filtration or separation medium of claim 1, wherein the porous polymeric particle is positively or negatively charged.

12. The filtration or separation medium of claim 1, further comprising a ligand covalently or non-covalently bound to the surface of the porous polymeric particle.

13. A method for separating a substance from a fluid, comprising the step of:
contacting with a fluid at a flow rate the filtration or separation medium of claim 1, wherein
the fluid comprises a substance; and
the pores of the porous polymeric particles are of sufficient size to substantially trap the substance, thereby separating the substance from the fluid.

14. A method for separating a substance from a fluid, comprising the step of:
contacting with a fluid at a flow rate the filtration or separation medium of claim 1, wherein
the fluid comprises a substance; and
the porous polymeric particle has an affinity for the substance, thereby separating the substance from the fluid.

15. A method of forming the filtration or separation medium of claim 1 comprising the steps of
contacting a polymer in a solvent, thereby creating a solution;
spraying the solution from a nozzle into a container, thereby creating a plurality of particles;
subjecting the plurality of particles to a first temperature, wherein the first temperature is less than about 15° C., thereby forming a plurality of frozen particles; and
removing substantially all of the solvent from the plurality of frozen particles, thereby forming a plurality of porous polymeric particles.

16. The method of claim 15, wherein the nozzle is an ultrasonic spray nozzle or a mechanical spray nozzle.

17. The method of claim 15, wherein subjecting the plurality of particles to the first temperature comprises contacting the plurality of particles with a freezing fluid or a cryogenic fluid, thereby forming the plurality of frozen particles.

18. The method of claim 15, wherein subjecting the plurality of particles to the first temperature comprises contacting the plurality of particles with a gas generated by a cryogenic fluid or a freezing fluid, thereby forming the plurality of frozen particles.

19. The method of claim 17, further comprising the step of: removing substantially all of the cryogenic fluid or the freezing fluid from the plurality of frozen particles.

20. The method of claim 15, wherein removing substantially all of the solvent from the plurality of frozen particles comprises subjecting the plurality of frozen particles to vacuum pressure for a second amount of time.

21. The method of claim 15, wherein removing substantially all of the solvent from the plurality of frozen particles comprises subjecting the plurality of frozen particles to a second temperature for a second amount of time.

22. The method of claim 15, wherein removing substantially all of the solvent from the plurality of frozen particles comprises sublimation or evaporation.

23. The method of claim 15, further comprising the step of modifying the surfaces of the plurality of porous polymeric particles.

24. The method of claim 23, wherein the surface modification is selected from the group consisting of coating, grafting, chemical oxidation, ligand binding, plasma treating, and crosslinking.
